(19) United States
(12) Patent Application Publication
(10) Pub. No.: US 2024/0239955 A1
(43) Pub. Date: Jul. 18, 2024

(54) BLENDED TEXTILE COMPOSITION WITH IMPROVED DYEING PROPERTIES

(71) Applicant: Parkdale, Incorporated, Gastonia, NC (US)

(72) Inventors: Robert A. USHER, JR., Charlotte, NC (US); Julia R. LOGAN, Charlotte, NC (US)

(73) Assignee: Parkdale, Incorporated, Gastonia, NC (US)

(21) Appl. No.: 18/565,077

(22) PCT Filed: May 5, 2022
(86) PCT No.: PCT/US22/27806

§ 371 Date: Nov. 28, 2023

Related U.S. Application Data
(60) Provisional application No. 63/194,234, filed on May 28, 2021.

(51) Int. Cl. C08G 63/672; D01D 1/04; D01D 5/08; D01F 6/84; D02G 3/04; D02G 3/34; D06P 1/16; D06P 1/38; D06P 3/82

(52) U.S. Cl. CPC C08G 63/672; D01D 1/04; D01D 5/08; D01F 6/84; D02G 3/04; D02G 3/34; D06P 3/8214; D06P 3/8233; D06P 1/16; D06P 1/38; D10B 2201/02; D10B 2331/04

(57) ABSTRACT

A copolymer composition with advantages for textile fibers, yarns, blended yarns, fabrics, and garments and methods for making and using the same are disclosed. The copolymer composition may comprise 84-86% terephthalic acid, 13-16% ethylene glycol, 0.5-1.5% caprolactone monomer, 0.1-2% pentaerythritol and/or 0.5-2% polyethylene glycol.

### CROSS-REFERENCE TO RELATED APPLICATION

This application is a 371 application of International Patent Application No. PCT/US22/27806, filed May 5, 2022, which is a PCT Application claiming priority to U.S. Provisional 63/194,234 filed May 28, 2021 tided POLYESTER COMPOSITION FOR FILAMENT, YARNS, AND FABRICS, each of which is incorporated in its entirety for all purposes.

### FIELD

A copolymer composition with advantages for textile fibers, yarns, blended yarns, fabrics, and garments and methods for making and using the same are disclosed.

### BACKGROUND

Synthetic compositions may be used to produce filaments and fibers. Such filaments and fibers are used in items comprising fabric. Working backward from one such item, a garment, informs the role of filaments, fibers, and yarns in the production of the final product. The garment is formed of a fabric that is typically either woven or knitted from yarns. In turn, yarns are formed from individual fibers joined together, for example, by a spinning process.

There are two primary types of processes by which synthetic fibers are manufactured—batch processes and continuous processes. Continuous production processes are, in generally, economically preferred over batch processes and can be carried out on a continuous polymerization line.

Natural fibers (such as cotton and wool, among others) may have inherent characteristics that produce certain properties in yarns, fabrics, and garments based upon the type of natural fiber that is used. For example, wool has excellent thermal properties, and remains insulating when wet. Unless treated properly, however, wool can be abrasive and thus uncomfortable when in contact with skin for extended intervals. In the same manner, different synthetic fibers may have some properties that are preferred over natural fibers. One of the goals in producing, designing, and developing synthetic compositions for eventual use as fibers, yarns, and fabrics is to produce a product that has desirable properties for the fabric's intended use. This often requires combining properties often found in certain natural fibers with complimentary properties found in certain synthetic fibers. It is common to blend synthetic fibers with natural fibers in proportions that produce a finished garment with the most desired properties for a particular purpose.

In the clothing industry, the ability to produce garments with desired colors is a fundamental goal. This can be achieved through the process of dyeing. Depending upon circumstances, fibers can be dyed as fiber, filament, yarn, fabric, or even as a garment. Fundamentally, the color of a garment will be based upon the chemical composition of the underlying fibers and the chemical composition of an appropriate dye composition and process.

The natures of the two different fibers, however, present practical problems when dying blended fabrics. One such problem is that the color of a dye is based upon the functional groups in the dye molecule. Stated differently, different colors in textiles are a function of dye molecules with different compositions. However, not all dye colors (i.e., the underlying molecules) perform in the same manner with natural and synthetic fibers, yarns, and garments. This gives rise to additional steps in the dyeing process for fabrics that are made from blended fibers and yarns to ensure desirable color properties.

Thus, a need exists for compositions that can produce a synthetic fiber with desirable color fastness properties when dyed at lower temperatures and/or pressures than traditional dyes. Further, the ability to produce such fibers in a continuous polymerization process is economically ideal.

### BRIEF SUMMARY

One or more embodiments of the invention may address one or more of the aforementioned problems.

In one aspect of the invention, a method of spinning a polyester copolymer filament is provided, the method comprising: polymerizing terephthalic acid, ethylene glycol, caprolactone monomer, pentaerythritol, and polyethylene glycol to form a polyester copolymer melt; and spinning the polyester copolymer melt into the polyester copolymer filament.

In another aspect of the invention, a method of forming a dyed yarn comprises dyeing a yarn blended from cotton and textured polyester copolymer staple fibers, wherein the yarn comprises from about 10 to about 90% cotton; and wherein the textured polyester copolymer staple fibers comprise terephthalic acid, ethylene glycol, caprolactone monomer, pentaerythritol, and polyethylene glycol.

In another aspect, a dyed fabric is provided. The dyed fabric comprising a reactive dye, a blended yarn comprising from about 10% to about 90% cotton or rayon, and a plurality of textured polyester copolymer staple fibers comprising terephthalic acid, ethylene glycol, caprolactone monomer, pentaerythritol, and polyethylene glycol.

In yet another aspect, a polyester copolymer filament is provided. The polyester copolymer filament comprising terephthalic acid, ethylene glycol, caprolactone monomer, pentaerythritol, and polyethylene glycol.

In a final aspect of the invention, a textile composition is given, the textile composition comprising terephthalic acid, ethylene glycol, caprolactone monomer, pentaerythritol, and polyethylene glycol.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates the concentration of caprolactone monomer present in the fiber produced by one embodiment of the disclosed invention as well as the concentration of caprolactone monomer in the overhead and vacuum.

FIG. 2 shows a table indicating pre-esterification ingredients and the mass of each in a 1000 g sample.

FIG. 3 illustrates the color properties of fabrics made from both standard polyester and the proposed invention when dyed between about 210° F. (99° C.) and about 220° F. (103° C.).

### DETAILED DESCRIPTION

As set forth herein, the goal of the invention is to produce a fiber that is based upon synthetic fiber can be dyed with a natural fiber. Specifically, a polyester (polyethylene terephthalate) fiber that can be dyed with cotton or rayon at or below 100 C.

As used herein, “dye” is defined as “a colorant that becomes molecularly dispersed at some point during application to a substrate and also exhibits some degree of permanence.” See Tortora, FAIRCHILD'S DICTIONARY OF TEXTILES, Seventh Edition, 2009 Fairchild Publications.

As used herein, “dyeability,” means the “capacity of fibers to accept dyes.” See Tortora, supra. Dyability is a property of the fiber itself.

As used herein, in the context of synthetic fibers and their manufacture, the term “melt viscosity” refers to the specific resistance of the melted polymer to deformation or flow under any given conditions. The term “intrinsic viscosity” is used to describe a characteristic that is directly proportional to the average molecular weight of a polymer. Intrinsic viscosity is calculated on the basis of the viscosity of a polymer solution (in a solvent) extrapolated to a zero concentration. Thus, the intrinsic viscosity is a characteristic that will affect the melt viscosity, but the melt viscosity is also related to other factors, particularly including the temperature of a melt.

In the textile art, terms such as “texturing” and “crimping,” are used both broadly and specifically. In the broadest sense, texturing and crimping are used as synonyms to refer to steps in which synthetic filament, staple fiber, or yarn is mechanically treated, thermally treated, or both, to have a greater volume then the untreated filament, staple, or yarn. In a narrower sense, the term crimping is used to describe the production of a two-dimensional sawtooth orientation in a filament, fiber or yarn, while the term texturing is used to refer to treatments that produce looping and curling. The meaning is generally clear in context. As used herein, the word “texture” is used in a broad sense to include all possibilities for producing the desired effect in a filament, staple fiber, or yarn.

Where “between” is used to indicate a number range, the range is inclusive of the numbers used. For example, “between about 10% and about 13%” is inclusive of both 10% and 13% as well as all numbers between 10% and 13%.

As used herein, “percent” or “%” means weight percent unless otherwise specified. Further, concentrations and proportions, unless otherwise stated, refer to the concentration or proportion in the finished copolymer.

As used herein, the term “pilling” is used to describe small undesired entanglements of fibers (“pills”) that can result when the surface of a fabric is abraded (including normal wear and tear).

A polyester (polyethylene terephthalate) fiber having desirable color fastness properties when dyed at lower temperatures and therefor lower pressures than traditional synthetic fibers is described.

Typically, cotton, rayon, and other various natural fibers are dyed with reactive or direct dyes at temperatures of about 66° C. and atmospheric pressure. Further, cotton dyeing tends to be driven by the pH of the dye solution or composition (typically in a basic environment); while polyester dyeing tends to be driven by the temperature, and conventionally requires the addition and performance of supplementary chemicals commonly referred to as “carriers” or “leveling agents.”

In contrast, polyester is typically dyed with dispersed dyes which require much higher temperatures (130° C. in most cases) and thus also may require pressurized equipment (above atmospheric pressure conditions) in order for the dye dispersion to penetrate the polyester. From the standpoint of economics, using disperse dyes is more expensive than using reactive dyes, particularly when high energy disperse dyes are used. High energy dyes are those dyes that are larger on the molecular level. They are used to give fabrics brighter colors, such as those colors used in clothing for safety purposes. In order for these larger molecules to penetrate the polymer chain of a traditional synthetic fabric, higher temperature and pressure is required.

With respect to the fibers disclosed herein, disperse dyes, including high energy dyes can be used at lower temperatures and pressures than in traditional synthetic fibers, resulting in a 50% or more decrease in dyeing expenses. This is at least partially attributable to decreased water usage and energy use, which see a reduction of 20% and 25%, respectively, per dye cycle.

Because of these differences in the dyeing compositions and the dyeing conditions, it is conventional practice to dye cotton and polyester separately. For example, blended cotton-polyester fabric may be dyed in two separate steps. In a first step, the fabric is dyed in a slightly acidic bath at a temperature of about 132° C. or higher (e.g., using a disperse dye) in order to get the polyester to accept the dye. The partially dyed fabric is then scoured or rinsed, and thereafter dyed in a cotton-appropriate dye (e.g., a direct or reactive dye) at a basic pH and at a temperature of about 66° C. Because many cotton dyestuffs will degrade at the polyester dying temperatures, the two steps cannot be combined.

Common compositions and methods of making polyester filaments, fibers, and yarns and the limitations resulting from such compositions and methods contribute to many of the difficulties in facilitating dyeing the fibers with natural fibers. One example of which is that additives are often used to control or adjust the properties of a polymer melt, and the features of such additives are likely to change either the dyeing characteristics or the spinning characteristics or both.

Another such example is that synthetic fibers—and certainly polyester—are typically manufactured by polymerizing the starting materials and thereafter extruding a melt of the polymer through small openings in a device referred to as a spinneret; a process referred to as “spinning.” Those experienced in synthetic and natural fibers will immediately recognize that the term “spinning” is used to refer to two entirely different processes. In one meaning (and since antiquity) spinning refers to the step of twisting individual fibers together and pulling them into a yarn. In the manufacture of synthetic fibers, the extrusion of filaments from a melt into solidified polymer filaments is also referred to as “spinning.” The difference is normally clear in context. Typically, the solidification of the extruded filaments is encouraged or advanced using a quenching step, in which a carefully controlled airflow is directed against the extruded filaments.

The properties required of a composition that can be melt and spun in this fashion, however, may be unrelated to, or disadvantageous in combination with, the properties that produce good dyeing characteristics. For example, in order to “spin” properly, a melted polymer must have a certain fluidity (viscosity) that permits the extrusion to produce coherent liquid filaments (i.e. that won't separate) at the spinneret while avoiding a viscosity that too low (“watery”) to control the spinning process for its intended purpose. Because the viscosity of a polymer melt is proportional to temperature, the degree of polymerization, and to other polymer properties, the spinning temperature must be appropriate as well. Stated differently, the melted polymer must be able to perform at the indicated temperature. Further, synthetic fibers originate as a filament, they must be cut and textured (not necessarily in that order) to gain other properties that are desirable in a finished yarn, fabric, or garment. In most cases, the texturing step requires that the synthetic filament or fiber be mechanically or thermally formed into a shape other than a straight extruded filament. Accordingly, the need to texturize polyester adds another set of properties that must be accounted for and that may compete against the properties that enhance polymerization, spinning, or dyeing.

Limited solutions known in the art for dyeing mixed-fiber fabrics require specialized equipment and the fabrics are ultimately expensive to produce. Further, they are difficult to process in certain conditions such as high heat and low humidity.

The present application discloses a dyeing process and recipe that can be used in textile equipment with significant modifications to the equipment, allows for lower temperatures and pressures during production and requires a decreased amount of ingredients. The disclosure contained herein further results in enhanced pilling performance and produces dyed mixed fiber fabrics at a reduced cost.

In one aspect of the invention, a method of spinning a polyester copolymer filament is provided, the method comprising: polymerizing terephthalic acid, ethylene glycol, caprolactone monomer, pentaerythritol, and polyethylene glycol to form a polyester copolymer melt; and spinning the polyester copolymer melt into the polyester copolymer filament. In some embodiments, polymerizing terephthalic acid, ethylene glycol, caprolactone monomer, pentaerythritol, and polyethylene glycol to form a polyester copolymer melt is carried out on a continuous polymerization line. Those having ordinary skill in the art will recognize that a continuous polymerization process may have various configurations with respect to the size, number, and specifications of the machinery used.

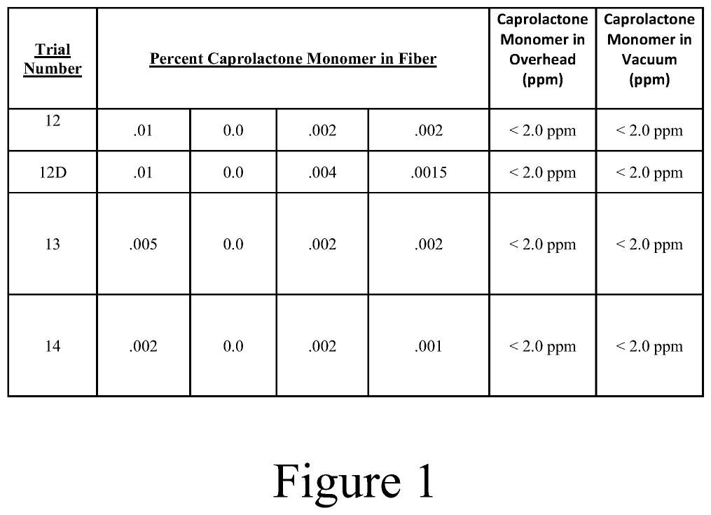

With reference to FIG. 1, a table is provided showing the concentration of caprolactone monomer in the resulting fiber as well as the overhead and vacuum of one continuous polymerization process configuration used to produce certain example embodiments of the present invention. In such production, the amount of each additive was varied within the parameters disclosed herein. As shown, only trace amounts of the caprolactone monomer was present in the fiber, the overhead, and the vacuum, thus supporting high product yield in a continuous process line.

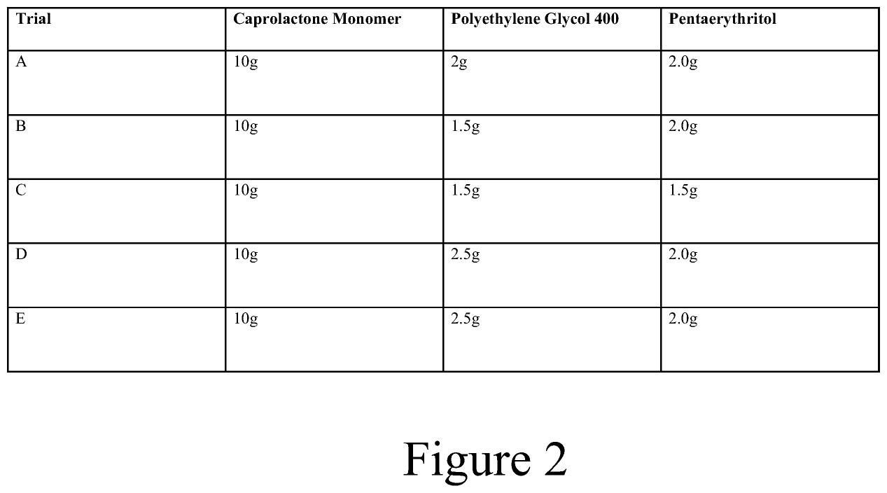

With reference to FIG. 2, a table is given showing the mass of Caprolactone Monomer, Polyethylene Glycol 400, and Pentaerythritol in five successful trials where a 1000 g sample produced in each trial. The concentration of ingredients may be varied according to several factors including, but not limited to, the color of the dyes applied.

The step of polymerizing terephthalic acid, ethylene glycol, caprolactone monomer, pentaerythritol, and polyethylene glycol comprises may comprise polymerizing 84%-86% terephthalic acid by weight of the polyester copolymer melt. Additionally or alternatively, polymerizing terephthalic acid, ethylene glycol, caprolactone monomer, pentaerythritol, and polyethylene glycol may comprise polymerizing 13-16% ethylene glycol by weight of the polyester copolymer melt. Additionally or alternatively, polymerizing terephthalic acid, ethylene glycol, caprolactone monomer, pentaerythritol, and polyethylene glycol may comprise polymerizing 0.5-1.5% caprolactone monomer by weight of the polyester copolymer melt. Alternatively or additionally, polymerizing terephthalic acid, ethylene glycol, caprolactone monomer, pentaerythritol, and polyethylene glycol may comprise polymerizing 0.1-2% pentaerythritol based on a total amount of polyester copolymer melt. Additionally or alternatively, polymerizing terephthalic acid, ethylene glycol, caprolactone monomer, pentaerythritol, and polyethylene glycol may comprise polymerizing 0.5-2% polyethylene glycol by weight of the polyester copolymer melt.

In some embodiments, the polyester copolymer melt comprises less than 2.5% diethylene glycol. In some embodiments, polymerizing terephthalic acid, ethylene glycol, caprolactone monomer, pentaerythritol, and polyethylene glycol comprises polymerizing terephthalic acid, ethylene glycol, caprolactone monomer, pentaerythritol, and polyethylene glycol at an intrinsic viscosity of between about 0.58 and 0.82. Given that conventional copolymers tend to run at lower intrinsic viscosities, the higher intrinsic viscosity of the invention is counterintuitive and novel. Further, the lower intrinsic viscosity in the conventional polymer requires reduced spinning temperature to spin and quench properly. However, because of the intrinsic viscosity ranges for the current invention, it can be polymerized between about 275° C. and 295° C. More particularly, the temperature may be between 285° C. and 295° C.

In some embodiments, the filament produced by the method is textured and cut into staple fiber. Texturing is well understood in the art and will not be otherwise described in detail, other than to point out that to date, the composition of the invention produces filament that can be textured using conventional steps (e.g., heat setting while in a twisted position).

In some embodiments, the staple fiber is spun into a blended yarn with cotton or rayon. Optionally, the blended yarn may be dyed to form a dyed yarn. The dyed yarn may then be used to form a fabric which can be used to create textiles such as garments and the like. Alternatively, the blended yarn can be woven or knitted into fabric and then dyed and then formed into a garment. In some circumstances, the dyeing step will be carried out on the garment. Reactive or dispersed dye may be used. Further, the process of dyeing may optionally be carried out at atmospheric pressure.

In another aspect of the invention, a method of forming a dyed yarn comprises dyeing a yarn blended from cotton and textured polyester copolymer staple fibers, wherein the yarn comprises from about 20 to about 80% cotton; and wherein the textured polyester copolymer staple fibers comprise terephthalic acid, ethylene glycol, caprolactone monomer, pentaerythritol, and polyethylene glycol. In some embodiments, the textured polyester copolymer staple fibers comprise 84-86% terephthalic acid by weight of the polyester copolymer melt. Additionally or alternatively, the textured polyester copolymer staple fibers may comprise 0.5-1.5% caprolactone monomer by weight of the polyester copolymer melt. Additionally or alternatively, the textured polyester copolymer staple fibers may comprise 13-16% ethylene glycol by weight of the polyester copolymer melt. Additionally or alternatively, the textured polyester copolymer staple fibers comprise 0.5-2% pentaerythritol based on a total amount of polyester copolymer melt. Additionally or alternatively, the textured polyester copolymer staple fibers may comprise 0.5-2% polyethylene glycol by weight of the polyester copolymer melt. Additionally or alternatively, the textured polyester copolymer staple fibers may comprise less than 2.5% diethylene glycol.

In some embodiments, dyeing the yarn blended from cotton and textured polyester copolymer staple fibers is carried out at atmospheric pressure and a temperature below 212° F. (100° C.). In certain embodiments, dyeing the cotton component of the yarn comprises dyeing the yarn with a reactive dye. In other embodiments, dyeing the polyester component of the yarn comprises dyeing the yarn with a disperse dye. The yarn produced by the method may be knitted or woven to form a knitted or woven fabric. The knitted or woven fabric can be used to create textiles such as garments and the like.

In another aspect of the invention, a textile composition comprising terephthalic acid, ethylene glycol, caprolactone monomer, pentaerythritol, and polyethylene glycol is provided. The textile may comprise 84-86% terephthalic acid. Additionally or alternatively, The textile composition comprises 13-16% ethylene glycol by weight of the polyester copolymer melt. Additionally or alternatively, the textile composition may comprise 0.5-1.5% caprolactone monomer. Additionally or alternatively, the textile composition may comprise 0.1-2% pentaerythritol. Additionally or alternatively, the textile composition may comprise 0.5-2% polyethylene glycol.

In some embodiments, the textile composition is used to make a polyester copolymer filament. The polyester copolymer filament may be textured to create a textured polyester copolymer filament and, optionally, textured polyester copolymer staple fiber may be manufactured therefrom. The textured polyester copolymer fiber may then be used to form a blended yarn comprising the textured polyester copolymer staple and a plurality of cotton fibers. In some embodiments, a dyed knitted fabric formed from the blended yarn is provided. In other embodiments, a dyed woven formed from the blended yarn is provided. In still other embodiments, a textile fabric comprising spandex and the polyester copolymer filament is provided.

In yet another aspect of the invention, a polyester copolymer filament is given. The polyester copolymer filament comprising: terephthalic acid; ethylene glycol; caprolactone monomer; pentaerythritol; and polyethylene glycol. The polyester copolymer filament may comprise 84-86% terephthalic acid. Additionally or alternatively, the polyester copolymer filament may comprise 13-16% ethylene glycol. Additionally or alternatively, the polyester copolymer filament may comprise 0.5-1.5% caprolactone monomer. Additionally or alternatively, the polyester copolymer filament may comprise 0.1-2% pentaerythritol. Additionally or alternatively, the polyester copolymer filament may comprise 0.5-2% polyethylene glycol.

In some embodiments, a textured polyester copolymer filament made from the polyester copolymer filament, is provided. The textured polyester copolymer filament may be used to form a textured polyester copolymer staple fiber, or a plurality thereof, that can be used in a blended yarn comprising the textured polyester copolymer staple fiber(s) and a plurality of cotton or rayon fibers. In some embodiments, the blended yarn comprises between about 10 and about 90 percent cotton or rayon. In some embodiments, a colorfast yarn comprising the blended yarn and a reactive dye is provided. Optionally, a fabric may be formed from the blended yarn and/or the colorfast yarn. The fabric may be prepared using any number of textile processing methods, resulting in a woven fabric comprising the blended or colorfast yarn, a knitted fabric comprising the blended or colorfast yarn, and the like.

In yet another aspect, a dyed fabric is provided, the dyed fabric comprising a reactive dye and a blended yarn comprising from about 10% to about 90% cotton or rayon, and a plurality of textured polyester copolymer staple fibers, the plurality of textured polyester copolymer staple fibers comprising terephthalic acid, ethylene glycol, caprolactone monomer, pentaerythritol, and polyethylene glycol. Additionally or alternatively, the plurality of textured polyester copolymer staple fibers may comprise 13-16% ethylene glycol. Additionally or alternatively, the plurality of textured polyester copolymer staple fibers may comprise 0.5-1.5% caprolactone monomer. Additionally or alternatively, the plurality of textured polyester copolymer staple fibers may comprise 0.1-2% pentaerythritol. Additionally or alternatively, the plurality of textured polyester copolymer staple fibers may comprise 0.5-2% polyethylene glycol.

In some embodiments, the dyed fabric is a woven fabric. In other embodiments, the dyed fabric is a knitted fabric. In some embodiments, a garment comprising the dyed fabric is provided.

In another aspect of the invention, a textile composition comprising terephthalic acid, ethylene glycol, caprolactone monomer, pentaerythritol, and polyethylene glycol is provided. The textile may comprise 84-86% terephthalic acid. Additionally or alternatively, The textile composition comprises 13-16% ethylene glycol by weight of the polyester copolymer melt. Additionally or alternatively, the textile composition may comprise 0.5-1.5% caprolactone monomer. Additionally or alternatively, the textile composition may comprise 0.1-2% pentaerythritol. Additionally or alternatively, the textile composition may comprise 0.5-2% polyethylene glycol.

In embodiments where 84-86% terephthalic acid is disclosed, the concentration of terephthalic acid may be between about 84% and about 84.1%, between about 84% and about 84.2%, between about 84% and about 84.3%, between about 84% and about 84.4%, between about 84% and about 84.5%, between about 84% and about 84.6%, between about 84% and about 84.7%, between about 84% and about 84.8%, between about 84% and about 84.9%, between about 84% and about 85%, between about 84% and about 85.1%, between about 84% and about 85.2%, between about 84% and about 85.3%, between about 84% and about 85.4%, between about 84% and about 85.6%, between about 84% and about 85.7%, between about 84% and about 85.8%, between about 84% and about 85.9%, between about 84% and about 86%, between about 85.9% and about 86%, between about 85.8% and about 86%, between about 85.7% and about 86%, between about 85.6% and about 86%, between about 85.5% and about 86%, between about 85.4% and about 86%, between about 85.3% and about 86%, between about 85.2% and about 86%, between about 85.1% and about 86%, between about 85% and about 86%, between about 84.9% and about 86%, between about 84.8% and about 86%, between about 84.7% and about 86%, between about 84.6% and about 86%, between about 84.3% and about 86%, between about 84.2% and about 86%, between about 84.1% and about 86%, and/or between about 84% and about 86%.

In embodiments where 13-16% ethylene glycol is disclosed, the concentration of ethylene glycol may be between about 13% and about 13.1% ethylene glycol, between about 13% and about 13.2%, between about 13% and about 13.3%, between about 13% and about 13.4%, between about 13% and about 13.5%, between about 13% and about 13.6%, between about 13% and about 13.7%, between about 13% and about 13.8%, between about 13% and about 13.9%, between about 13% and about 14%, between about 13% and about 14.1%, between about 13% and about 14.2%, between about 13% and about 14.3%, between about 13% and about 14.4%, between about 13% and about 14.5%, between about 13% and about 14.6%, between about 13% and about 14.7%, between about 13% and about 14.8%, between about 13% and about 14.9%, between about 13% and about 15%, between about 13% and about 15.1%, between about 13% and about 15.2%, between about 13% and about 15.3%, between about 13% and about 15.4%, between about 13% and about 15.5%, between about 13% and about 15.6%, between about 13% and about 15.7%, between about 13% and about 15.8%, between about 13% and about 15.9%, between about 13% and about 16%, between about 13.1% and about 16%, between about 13.2% and about 16%, between about 13.3% and about 16%, between about 13.4% and about 16%, between about 13.5% and about 16%, between about 13.6% and about 16%, between about 13.7% and about 16%, between about 13.8% and about 16%, between about 13.9% and about 16%, between about 14% and about 16%, between about 14.1% and about 16%, between about 14.2% and about 16%, between about 14.3% and about 16%, between about 14.4% and about 16%, between about 14.5% and about 16%, between about 14.6% and about 16%, between about 14.7% and about 16%, between about 14.8% and about 16%, between about 14.9% and about 16%, between about 15% and about 16%, between about 15.1% and about 16%, between about 15.2% and about 16%, between about 15.3% and about 16%, between about 15.4% and about 16%, between about 15.5% and about 16%, between about 15.6% and about 16%, between about 15.7% and about 16%, between about 15.8% and about 16%, and/or between about 15.9% and about 16%.

In embodiments where 0.5-1.5% caprolactone monomer is disclosed, the concentration of caprolactone monomer may be between about 0.5% and about 0.6%, between about 0.5% and about 0.7%, between about 0.5% and about 0.8%, between about 0.5% and about 0.9%, between about 0.5% and about 1.0%, between about 0.5% and about 1.1%, between about 0.5% and about 1.2%, between about 0.5% and about 1.3%, between about 0.5% and about 1.4%, between about 0.5% and about 1.5%, between about 0.6% and about 1.5%, between about 0.7% and about 1.5%, between about 0.8% and about 1.5%, between about 0.9% and about 1.5%, between about 1.0% and about 1.5%, between about 1.1% and about 1.5%, between about 1.2% and about 1.5%, between about 1.3% and about 1.5%, and/or between about 1.4% and about 1.5%.

In embodiments where 0.1-2% pentaerythritol is disclosed, the concentration of pentaerythritol may be between about 0.1% and about 0.3%, between about 0.1% and about 0.4%, between about 0.1% and about 0.5%, between about 0.1% and about 0.6%, between about 0.1% and about 0.7%, between about 0.1% and about 0.8%, between about 0.9% and about 1.0%, between about 0.1% and about 1.1%, between about 0.1% and about 1.2%, between about 0.1% and about 1.3%, between about 0.1% and about 1.4%, between about 0.1% and about 1.5%, between about 0.1% and about 1.6%, between about 0.1% and about 1.7%, between about 0.1% and about 1.8%, between about 0.1% and about 1.9%, between about 0.1% and about 2%, between about 0.2% and about 2%, between about 0.3% and about 2%, between about 0.4% and about 2%, between about 0.5% and about 2%, between about 0.6% and about 2%, between about 0.7% and about 2%, between about 0.8% and about 2%, between about 0.9% and about 2%, between about 1.0% and about 2%, between about 1.1% and about 2%, between about 1.2% and about 2%, between about 1.3% and about 2%, between about 1.4% and about 2%, between about 1.5% and about 2%, between about 1.6% and about 2%, between about 1.7% and about 2%, between about 1.8% and about 2%, and/or between about 1.6% and about 2%.

In embodiments where 0.5-2% polyethylene glycol is disclosed, the concentration of polyethylene glycol may be between about 0.5% and about 0.6%, between about 0.5% and about 0.7%, between about 0.5% and about 0.8%, between about 0.5% and about 0.9%, between about 0.5% and about 1.0%, between about 0.5% and about 1.1%, between about 0.5% and about 1.2%, between about 0.5% and about 1.3%, between about 0.5% and about 1.4%, between about 0.5% and about 1.5%, between about 0.5% and about 1.6%, between about 0.5% and about 1.7%, between about 0.5% and about 1.8%, between about 0.5% and about 0.6%, between about 0.5% and about 2.0%, between about 0.6% and about 2.0%, between about 0.7% and about 2.0%, between about 0.8% and about 2.0%, between about 0.9% and about 2.0%, between about 1.0% and about 2.0%, between about 1.1% and about 2.0%, between about 1.2% and about 2.0%, between about 1.3% and about 2.0%, between about 1.4% and about 1.5%, between about 1.6% and about 2.0%, between about 1.7% and about 2.0%, between about 1.8% and about 2.0%, and/or between about 1.9% and about 2.0%.

### Example 1

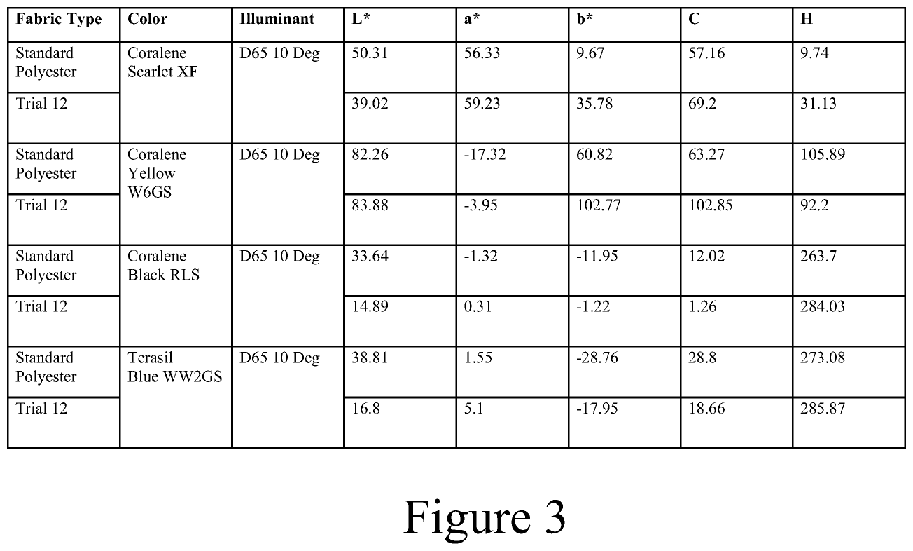

Dying trials were conducted at temperatures between about 99° C. and about 103° C. on both 10 grams of fabric produced in a manner that is consistent with that of standard polyester and 10 grams of present invention. In each trial, 30 mL of a 1% dye solution, 2 mL of a 10% DLS Leveler solution, 2 mL of a 10% Albatex-45 solution, and 2 mL of acetic acid were applied to the fabric. The results of these trials are shown in FIG. 3. The variation in temperature used can be to adjust for the dye coloring or a variety of other factors. In the specification there has been set forth a preferred embodiment of the invention, and although specific terms have been employed, they are used in a generic and descriptive sense only and not for purposes of limitation, the scope of the invention being defined in the claims.

1. A method of spinning a polyester copolymer filament, the method comprising:
polymerizing terephthalic acid, ethylene glycol, caprolactone monomer, pentaerythritol, and polyethylene glycol to form a polyester copolymer melt; and
spinning the polyester copolymer melt into the polyester copolymer filament.

2. The method of claim 1, wherein polymerizing terephthalic acid, ethylene glycol, caprolactone monomer, pentaerythritol, and polyethylene glycol to form a polyester copolymer melt is carried out on a continuous polymerization line.

3. The method of claim 1, wherein polymerizing terephthalic acid, ethylene glycol, caprolactone monomer, pentaerythritol, and polyethylene glycol to form a polyester copolymer melt is carried out on a batch reactor.

4. The method of claim 1, wherein polymerizing terephthalic acid, ethylene glycol, caprolactone monomer, pentaerythritol, and polyethylene glycol comprises polymerizing;
84%-86% terephthalic acid by weight of the polyester copolymer melt;
13-16% ethylene glycol by weight of the polyester copolymer melt;
0.5-1.5% caprolactone monomer by weight of the polyester copolymer melt;
0.1-2% pentaerythritol based on a total amount of polyester copolymer melt; and
0.5-2% polyethylene glycol by weight of the polyester copolymer melt.

5-8. (canceled)

9. The method of claim 1, wherein the polyester copolymer melt comprises less than 3% diethylene glycol.

10. The method of claim 1, wherein polymerizing terephthalic acid, ethylene glycol, caprolactone monomer, pentaerythritol, and polyethylene glycol comprises polymerizing terephthalic acid, ethylene glycol, caprolactone monomer, pentaerythritol, and polyethylene glycol at an intrinsic viscosity of between about 0.58 and 0.82 and a temperature of between about 275° C. and 295° C.

11-22. (canceled)

23. A method of forming a dyed yarn, the method comprising:
dyeing a yarn blended from cotton and textured polyester copolymer staple fibers,
wherein the yarn comprises from about 10 to about 90% cotton; and
wherein the textured polyester copolymer staple fibers comprise terephthalic acid, ethylene glycol, caprolactone monomer, pentaerythritol, and polyethylene glycol.

24. The method of claim 23, wherein the textured polyester copolymer staple fibers comprise:
84-86% terephthalic acid by weight of the polyester copolymer melt;
0.5-1.5% caprolactone monomer by weight of the polyester copolymer melt;
13-16% ethylene glycol by weight of the polyester copolymer melt;
0.1-2% pentaerythritol based on a total amount of polyester copolymer melt; and
0.5-2% polyethylene glycol by weight of the polyester copolymer melt.

25-28. (canceled)

29. The method of claim 23, wherein the textured polyester copolymer staple fibers comprise less than 2.5% diethylene glycol.

30. The method of claim 23, wherein dyeing the yarn blended from cotton and textured polyester copolymer staple fibers is carried out at atmospheric pressure and a temperature below 100° C.

31. The method of claim 23, wherein dyeing the cotton component of the yarn comprises dyeing the yarn with a reactive dye.

32. The method of claim 23, wherein dyeing the polyester component of the yarn comprises dyeing the yarn with a disperse dye.

33-36. (canceled)

37. A textile composition comprising:
terephthalic acid;
ethylene glycol;
caprolactone monomer;
pentaerythritol; and
polyethylene glycol.

38. The textile composition of claim 37, wherein the textile composition comprises:
84-86 wt % terephthalic acid;
13-16 wt % ethylene glycol;
0.5-1.5 wt % caprolactone monomer;
0.1-2 wt % pentaerythritol; and
0.5-2 wt % polyethylene glycol.

39-42. (canceled)

43. A polyester copolymer filament made from the textile composition of claim 37.

44. A textured polyester copolymer filament made from the polyester copolymer filament of claim 43.

45. A textured polyester copolymer staple fiber made from the textured polyester copolymer filament of claim 44.

46. A blended yarn comprising:
the textured polyester copolymer staple fiber of claim 45; and
a plurality of cotton fibers.

47. A dyed knitted fabric comprising the blended yarn of claim 46.

48. A dyed woven fabric comprising the blended yarn of claim 46.

49. A textile fabric comprising:
spandex; and
the polyester copolymer filament of claim 43.

50-75. (canceled)
